(19) United States
(12) Patent Application Publication
(10) Pub. No.: US 2026/0082369 A1
(43) Pub. Date: Mar. 19, 2026

(54) Methods For Determining Array Associated With Resource Allocation In An Integrated Sensing And Communication System With Time-Division Duplexing Channel

(71) Applicant: MediaTek Inc., Hsinchu City (TW)

(72) Inventors: Jiaying Ren, San Jose, CA (US); Shiauhe Shawn Tsai, San Jose, CA (US)

(73) Assignee: MediaTek Inc., Hsinchu City (TW)

(21) Appl. No.: 19/326,669

(22) Filed: Sep. 11, 2025

Related U.S. Application Data
(60) Provisional application No. 63/696,409, filed on Sep. 19, 2024.

(51) Int. Cl. H04W 72/04; H04L 5/14

(52) U.S. Cl. CPC H04W 72/04; H04L 5/1469

(57) ABSTRACT

Various solutions for determining array associated with resource allocation in an Integrated Sensing and Communication (ISAC) system with Time-Division Duplexing (TDD) channel with respect to an apparatus in mobile communications are described. The apparatus may determine an array according to one or more kernels. The array may be associated with a resource allocation. In at least one kernel, elements may be associated with unavailable resource units. The apparatus may transmit a plurality of signals based on the array associated with the resource allocation.

### CROSS REFERENCE TO RELATED PATENT APPLICATION(S)

The present disclosure is part of a non-provisional application claiming the priority benefit of U.S. Patent Application No. 63/696,409, filed 19 Sep. 2024, the contents of which herein being incorporated by reference in its entirety.

### TECHNICAL FIELD

The present disclosure is generally related to an Integrated Sensing and Communication (ISAC) system, and, more particularly, to determining arrays associated with resource allocation in an ISAC system with Time-Division Duplexing (TDD) channel.

### BACKGROUND

Unless otherwise indicated herein, approaches described in this section are not prior art to the claims listed below and are not admitted as prior art by inclusion in this section.

Regarding New Radio (NR) mobile communications, in some network environments related to radar engineering, the detection of surrounding objects may typically be achieved through the measurement of signal delay and Doppler shift. Wireless signals, transmitted across frequency, time, and/or spatial domains for communication purposes, exhibit radio characteristics analogous to those employed in sensing applications. These characteristics may be repurposed to enable dual communication and sensing functionalities. The design and implementation of multi-dimensional large-scale sparse arrays may represent a critical area of research in the field of Integrated Sensing and Communication (ISAC) systems, as such arrays provide a foundation for optimizing performance, reducing resource overhead, and addressing the challenges associated with simultaneous sensing and communication requirements. However, the designs of these large-scale arrays may be complicated so that the computational complexity may be significantly high.

In addition, in practical ISAC systems that seek to reuse resources in a specific domain (e.g., in a Time-Division Duplexing (TDD) channel that multiplexes Uplink (UL) and Downlink (DL) transmissions in the time domain), the reality of the duplexing operation may impose new restrictions. In particular, when considering DL sensing in the ISAC system, some slots or symbols that are allocated for UL transmissions or switching slots for UL-DL transitions may not be utilized for sensing. This may result in sensing resource allocation constraints that must be accounted for to ensure the compatibility of the sensing resource pattern with the UL/DL duplexing structure of the system. Therefore, these constraints need to be carefully integrated into the designs of sensing signal placements or large-scale arrays to ensure that sensing signals are only placed within the permissible DL resources.

Accordingly, the development of an array design scheme that minimizes computational complexity and improves sensing accuracy has become a critical consideration in some network scenarios of modern wireless communication networks (e.g., the ISAC systems with TDD channels). Therefore, there is a recognized need for effective schemes that enable a more streamlined and efficient array design process.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to determining arrays associated with resource allocation in an ISAC system using given-domain multiplexing schemes (e.g., Time-Division Duplexing (TDD) channel) with respect to apparatus in mobile communications. For those skilled in the art, generalization from Time-Division Duplexing (TDD) to other domain multiplexing is straightforward. Without loss of generality, the description of general domain multiplexing schemes is exemplified by TDD.

In one aspect, a method may involve an apparatus determining an array according to one or more kernels. The array may be associated with a resource allocation. In at least one kernel, elements may be associated with unavailable resource units. The method may also involve the apparatus performing at least one of a transmission and a reception of a plurality of signals based on the array associated with the resource allocation.

In one aspect, an apparatus may comprise at least one of a transmitter and a receiver which, during operation, wirelessly communicates with a wireless network. The apparatus may also comprise a processor communicatively coupled to the at least one of the transmitter and the receiver. The processor may perform operations comprising determining an array according to one or more kernels. The array may be associated with a resource allocation. In at least one kernel, elements may be associated with unavailable resource units. The processor may further perform operations comprising performing, via the at least one of the transmitter and the receiver, at least one of a transmission and a reception of a plurality of signals based on the array associated with the resource allocation.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1A is a diagram depicting an example scenario under schemes in accordance with implementations of the present disclosure.

FIG. 1B is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a block diagram of an example communication apparatus in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to determining arrays associated with resource allocation in an ISAC system with a TDD channel with respect to apparatus in mobile communications. According to the present disclosure, a number of possible solutions may be implemented separately or jointly. That is, although these possible solutions may be described below separately, two or more of these possible solutions may be implemented in one combination or another.

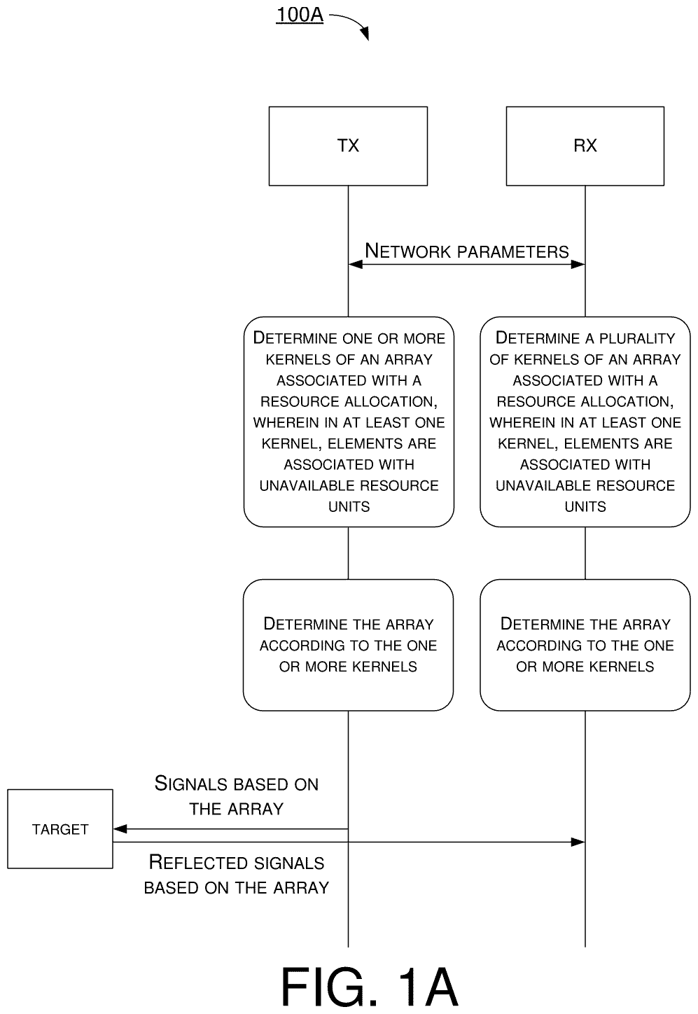

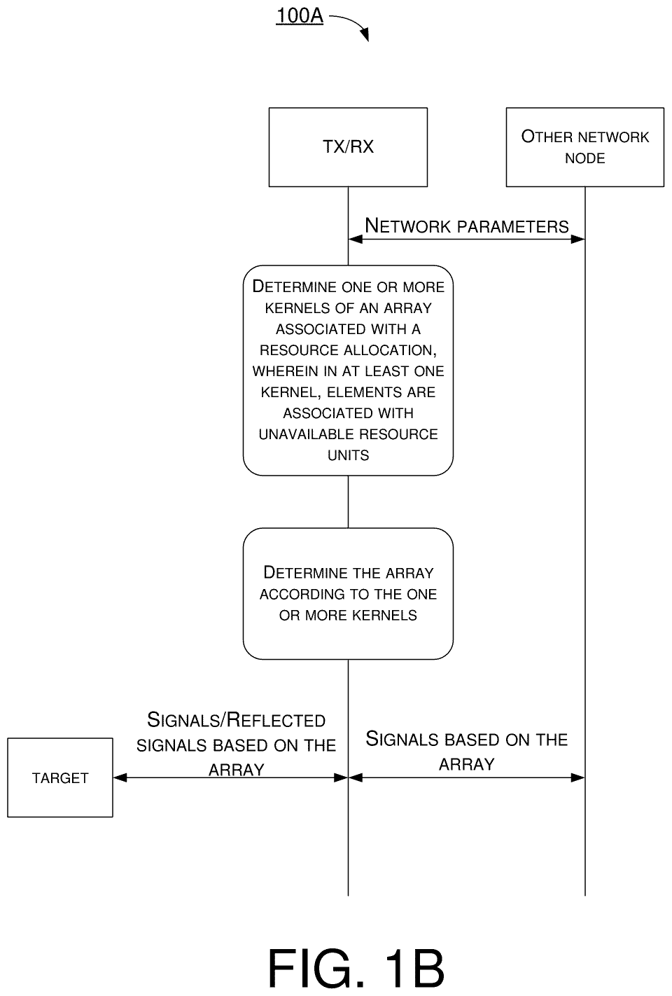

FIG. 1A illustrates an example scenario 100A under schemes in accordance with implementations of the present disclosure. In some network scenarios, an apparatus (e.g., a user equipment (UE) or a network node) as a transmitter (TX) and an apparatus (e.g., a UE or a network node) as a receiver (RX) may exchange necessary network parameters. Next, the TX apparatus and the RX apparatus may respectively determine an array according to one or more kernels. The array may be associated with a resource allocation. In at least one determined kernel, elements may be associated with unavailable resource units. After determining the array, the TX apparatus may transmit signals (i.e., perform a transmission of the signals) to sensing targets, and the RX apparatus may receive the signals (i.e., perform a reception of the signals) reflected from the sensing targets (e.g., for sensing and communication purposes under bistatic sensing network scenarios) based on the array associated with the resource allocation.

FIG. 1B illustrates an example scenario 100B under schemes in accordance with implementations of the present disclosure. In some network scenarios, an apparatus (e.g., a UE or a network node) as both a TX and an RX may exchange necessary network parameters with other network nodes. Next, the apparatus may determine an array according to one or more kernels. The array may be associated with a resource allocation. In at least one determined kernel, elements may be associated with unavailable resource units. After determining the array, the apparatus may transceive (i.e., perform both transmission and reception) signals (e.g., for sensing targets and communication with other network nodes under monostatic sensing network scenarios) based on the array associated with the resource allocation.

Based on determining the kernels of the array, the design problem of the array may be simplified to several minor design problems of the kernels, which may significantly reduce the computational complexity. Accordingly, effective schemes that enable a more streamlined and efficient array design process may be provided.

More specifically, a multi-tier array structure (i.e., an array structure composed of the kernels) for a multi-dimensional array (e.g., a large-scale sparse array) design may be introduced. By using the multi-tier array structure, the array design problem may be simplified to several kernel design problems. The multi-tier array structure may inherently enable a systematic construction of multi-dimensional array patterns, significantly reducing computational complexity for array selection (e.g., sparse array selection) and minimizing the required storage area, potentially eliminating the need for storage entirely.

Further, the multi-tier array structure may be introduced for low overhead and high performance sensing resource allocation for sensing and positioning in Orthogonal Frequency Division Multiplexing (OFDM) Integrated Sensing and Communication (ISAC) systems, sparse transmission/reception antenna array design for beamforming in massive Multi-Input Multi-Output (MIMO), and other applications requiring a large-scale sparse array. The method may be generally applicable to any resource grids that are used as sampling instances; thus, it is not restricted to the OFDM resource element (RE) plane but also helps heterogeneous time division multiplexing (TDM) radars.

In some embodiments, regarding an ISAC system with a TDD channel, TX/RX of the ISAC system may determine one or more kernels of an array associated with a resource allocation. In at least one kernel, elements may be associated with unavailable resource units. In some cases, the unavailable resource units may include non-Downlink (non-DL) symbols in a Time-Division Duplexing (TDD) channel that are inactivated. In some cases, the non-DL symbols may include Uplink (UL) symbols of at least one UL slot. In some cases, in addition to the UL symbols, the non-DL symbols may further include a part of symbols of at least one switching slot (i.e., slot for UL-DL transitions), while the part of symbols may not be used for sensing.

More specifically, during the determination of each kernel among one or more kernels of the array, the selection or activation of elements within the respective kernel may be subject to a constraint based on the association of the elements with non-DL symbols. For each kernel, elements that are associated with non-DL symbols (including but not limited to UL symbols of at least one UL slot and, in some implementations, at least a portion of symbols of at least one switching slot) may be identified as unavailable for sensing purposes. Such elements may be explicitly deactivated (e.g., set to zero) during the kernel design process, which may ensure that each kernel within the multi-tier structured array adheres to the DL resource allocation restrictions imposed by the duplexing structure of the TDD channel, thereby preventing the allocation of sensing signals to any element associated with UL or switching symbols.

Then, the TX/RX may determine the array according to the determined kernels. After determining the array, the TX/RX may transmit and/or receive signals based on the array associated with the resource allocation in the TDD channel. For example, a UE as the TX may transmit the signals to a network node as the RX based on the array associated with the resource allocation in the TDD channel. Conversely, a network node, such as the TX, may transmit the signals to a UE, such as the Rx, based on the array associated with the resource allocation in the TDD channel. Furthermore, an apparatus (e.g., network node or UE) that acts as both TX and RX may transceive signals based on the array associated with the resource allocation in the TDD channel.

In some implementations, the ISAC system may include the TX transmitting OFDM signals with a cyclic prefix (CP) to serve both communication and sensing purposes simultaneously. The generalization of a time-frequency grid, with the CP part omitted, to a horizontal-vertical uniform planar array axis may be straightforward. In some cases, within a coherent processing interval, the CP-OFDM signal may include M slots, where each slot may include L symbols, each symbol may consist of P subcarriers, and a subcarrier spacing (SCS) may be

$${Δ}_{f} = \frac{1}{T} .$$

The duration of each symbol may be Tₛ=T+T_{cp}, where T_{cp} may be a CP length. In the ISAC system, a TDD channel with DL, UL, and switching slots may be used for notational brevity. The DL time slots may be substituted by any designated sensing resource blocks. Let [symbol] ={1, 2, . . . , M}, in some cases, [symbol] _{D} ⊂ [symbol] may be a set of slot indices of DL slots, [symbol] _{U} ⊂ [symbol] may be a set of slot indices of UL slots, and [symbol] _{S} ⊂ [symbol] may be a set of slot indices for slots designated for switching purposes. Let Q=ML and [symbol] ={1, 2, . . . , Q}, in some cases, [symbol] _{D} may be a set of symbol indices of the symbols that may be used as DL symbols (or designated resource available for sensing in the general sense). For q∈ [symbol] _{D}, a DL transmitted baseband signal in the qth symbol may be given by:

$${x}^{q} ( t ) = {\sum }_{p = 1}^{P} s ( p , q ) {e}^{j 2 π ( p - 1 ) {Δ}_{f} t} δ ( t - ( q - 1 ) {T}_{s} )$$

$$with$$

$$δ ( t ) = \{ \begin{matrix}1 , & t ∈ [ - {T}_{cp} , T ] \\ 0 , & otherwise\end{matrix}$$

where t may denote the time and s(p,q) may be the transmitted symbol at the pth subcarrier of the qth symbol.

In DL sensing, the RX may have information of the DL sensing signal and utilize the received DL sensing signal to estimate target parameters. Let a matrix A∈{0,1}^{P×Q} representing an allocation of DL sensing signals, the (p, q)th element of A, denoted as a(p, q), being 1 may indicate the presence of a DL sensing resource element (RE), while a value of 0 may indicate an allocation to data, UL, or other purposes not for sensing. In some cases, the transmitted symbol s(p, q) may be generated based on a(p, q). In particular, s(p, q) may be set to a known sensing symbol when a(p, q)=1, and may be set to a data symbol or another type of symbol when a(p, q)=0.

Let Ω={(p,q): A(p,q)=1 for p∈[1, . . . , P], q∈[1, . . . , Q]} be a set of sensing RE indices, and N_{D} be a number of nonzero elements in A, in some cases, there may be N targets, and the reflection coefficient, the delay and the Doppler frequency of the nth target may be ãₙ, τₙ, and

$${f}_{n}^{d} ,$$

respectively. After down-conversion, the corresponding baseband sensing echo signals received by the RX may be:

$$\tilde{y} ( t ) = {\sum }_{q ∈ {ℚ}_{D}} {\sum }_{n} {\tilde{α}}_{n} {e}^{j 2 π {f}_{n}^{d} ( q - 1 ) {T}_{s}} {x}^{q} ( t - {τ}_{n} ) + \tilde{v} ( t )$$

where \tilde{v}(t)˜CN(0, σ²) is the additive Gaussian noise.

In some cases, all targets' delays may be less than T_{cp}. After CP removal, Fast Fourier Transform (FFT) and the subsequent element-wise division, for (p, q)∈Ω, the corresponding baseband echo signals from the DL sensing signals at the pth subcarrier in the qth symbol may be expressed as:

$$y ( p , q ) = {\sum }_{n} {α}_{n} {e}^{j 2 π {f}_{n}^{d} ( q - 1 ) {T}_{s}} {e}^{- j 2 π {Δ}_{f} {τ}_{n} ( p - 1 )} + v ( p , q )$$

where

$$v ( p , q ) ∼ N ( 0 , \frac{P {σ}^{2}}{{\vert s ( p , q ) \vert}^{2}} ) .$$

It should be noted that for sensing signals, |s(p, q)|=1, resulting in (p, q)˜N(0,Pσ²).

In a noiseless case, the standard delay-Doppler image of the targets may have the following form:

$${P}^{t} ( τ , {f}^{d} ) = {\sum }_{n} {α}_{n} P ( {τ}_{n} - τ , {f}_{n}^{d} - {f}^{d} )$$

where P(τ, f^{d}) may be a Point Spread Function (PSF) defined as:

$$P ( τ , {f}^{d} ) = \frac{1}{{N}_{D}} {\sum }_{p = 1}^{P} {\sum }_{q = 1}^{Q} a ( p , q ) {e}^{- j 2 π {Δ}_{f} τ ( p - 1 )} {e}^{j 2 π {f}^{d} ( q - 1 ) {T}_{s}}$$

The PSF P(τ, f^{d}) may vary significantly based on the placement of the sensing signals, and may be important for the high performance delay-Doppler imaging of targets.

In some implementations, the sensing signal overhead, which may include the number of Resource Elements (REs) allocated to the sensing signals, may be reduced while ensuring the performance of the delay-Doppler imaging for targets. The following sensing signal placement design criteria may be fulfilled: (1) for q ∉Q_{D}, meaning for symbols that are not allocated for sensing, a(p, q)=0 may be set; (2) a specific beamwidth (e.g., half power beamwidth) of a mainlobe in delay and Doppler may be limited within some desired values of Δ₁ and Δ₂, respectively; (3) a peak sidelobe level (PSL) of the delay-Doppler image may be limited under a desired value γ; and (4) the number of REs allocated to sensing signals may be small (e.g., minimized).

Although the foregoing mathematical description assumed DL sensing signal placement, the principles described hereinafter are, without loss of generality, applicable to the design of transmitted sensing signal patterns over one-, two-, or even higher dimensional resource domains. These principles aim to meet the desired mainlobe half-power beamwidth (HPBW) and PSL limitations while minimizing the number of active elements, as achieved by the proposed search algorithms as described in the following descriptions.

In some implementations, an L-tier structured array with size P×Q and array pattern A∈{0,1}^{P×Q} may be utilized. In some cases, P=P₁× . . . ×P_{L} and Q=Q₁× . . . ×Q_{L}. The L-tier structured array may consist of L kernels, where a size of the lth tier kernel may be Pₗ×Qₗ, and an array pattern of the lth tier kernel may be Aₗ ∈{0,1}^{P}^{ᵢ}^{×Q}^{ᵢ}. The array pattern of the structured array may be obtained by using A=A_{L}⊗A_{L-1}⊗ . . . ⊗A₁, where ⊗ denote the Kronecker product operator. In some cases, N_{D}=N₁ . . . N_{L}, where Nₗ may be the number of nonzero elements in Aₗ. The PSF of the L-tier structured array may be expressed as:

$$P ( τ , {f}^{d} ) = \frac{1}{{N}_{D}} {\sum }_{p = 1}^{P} {\sum }_{q = 1}^{Q} a ( p , q ) {e}^{- j 2 π {Δ}_{f} τ ( p - 1 )} {e}^{j 2 π {f}^{d} ( q - 1 ) {T}_{s}} = {P}_{L} ( τ , {f}^{d} ) … {P}_{2} ( τ , {f}^{d} ) {P}_{1} ( τ , {f}^{d} )$$

where Pₗ(τ, f^{d}) may be the PSF of the lth tier kernel, and

$${P}_{l} ( τ , {f}^{d} ) = \frac{1}{{N}_{l}} {\sum }_{{p}_{l} = 1}^{P} {\sum }_{{q}_{l} = I}^{Q} a ( p , q ) {e}^{- j 2 π {Δ}_{f} τ {P}_{1} … {P}_{l - 1} ( {p}_{l} - 1 )} {e}^{j 2 π {f}^{d} {Q}_{1} … {Q}_{l - 1} ( {q}_{l} - 1 ) {T}_{s}}$$

Accordingly, a P×Q array design may be simplified to L kernel designs. The sizes of the lth-tier kernel may be Pₗ×Qₗ for l=1, . . . , L.

In some cases, regarding the lth-tier kernel, let P₀=1 and Q₀=1, for l=1, . . . , L, Pₗ(τ, f^{d}) may be two-dimensional periodic function with periods of

$$\frac{1}{{P}_{0} … {P}_{l - 1} {Δ}_{f}}$$

in the first dimension and

$$\frac{1}{{Q}_{0} … {Q}_{l - 1} {T}_{s}}$$

in the second dimension. Pₗ(τ, f^{d}) may exhibit periodic grating lobes at

$$τ = \frac{p}{{P}_{0} … {P}_{l - 1} {Δ}_{f}} , {f}^{d} = \frac{q}{{Q}_{0} … {Q}_{l - 1 {T}_{s}}} ,$$

where p, q may be integers satisfying

$$\vert τ \vert \leq \frac{1}{2 {Δ}_{f}} and \vert {f}^{d} \vert \leq \frac{1}{2 {T}_{s}}$$

and at least one of them may be nonzero. Specific beamwidth (e.g., half power beamwidth) of the mainlobe of the l-th tier kernel may be about

$${Δ}_{τ}^{l} = \frac{1}{{P}_{1} … {P}_{l} {Δ}_{f}} and {Δ}_{{f}^{d}}^{l} = \frac{1}{{Q}_{1} … {Q}_{l} {T}_{s}} .$$

Therefore, for l′>l, P_{l′}(τ, f^{d}) may typically have a smaller maximum unambiguous region (i.e., a smaller period), but finer mainlobe (i.e., a higher resolution) compared to Pₗ(τ, f^{d}).

In some implementations, the plurality of kernels may include L number of kernels. The L-tier structure array may be a Kronecker product of the L kernels according to the following formula:

$$A = {A}_{L} ⊗ {A}_{L - 1} ⊗ {A}_{L - 2} ⊗ … ⊗ {A}_{2} ⊗ {A}_{1}$$

where A may be the array, and A₁ to A_{L} may be the L kernels. In addition, a size of the array may be P×Q, a size of Aᵢ may be Pᵢ×Qᵢ, P may be equal to P₁×P₂× . . . ×P_{L-1}×P_{L}, and Q may be equal to Q₁×Q₂× . . . ×Q_{L-1}×Q_{L}.

More specifically, A∈{0,1}^{P×Q} may denote an array pattern of the array with size P×Q. When it is designed that P=P₁×P₂× . . . ×P_{L-1}×P_{L} and Q=Q₁×Q₂× . . . ×Q_{L-1}×Q_{L}, array A with size P×Q may be determined by using the kernel with size Pᵢ×Qᵢ while Aᵢ∈{0,1}^{P}^{ᵢ}^{×Q}^{ᵢ}, represented as A=A_{L} ⊗A_{L-1}⊗A_{L-2} ⊗ . . . ⊗A₂ ⊗A₁.

In some cases, an array factor for the array A (e.g., a spectral response of the array A) may be determined according to the following formula:

$$f ( {α}_{1} , {α}_{2} ) = {\sum }_{q = 1 , p = 1}^{Q , P} A ( p , q ) exp ( - j 2 π {α}_{2} ( q - 1 ) ) exp ( j 2 π {α}_{1} ( p - 1 ) )$$

where f(α₁, α₂) may be the array factor for the array, A(p, q) may be pth row and qth column element of the array A, A(p, q) may be an activated element in an event that A(p, q) is 1, and A(p, q) may not be an activated element in an event that A(p, q) is 0.

In some cases, an array factor for the kernel Aᵢ (e.g., a spectral response of the array Aᵢ) may be determined according to the following formula:

$${f}_{i} ( {α}_{1} , {α}_{2} ) = {\sum }_{{q}_{i} = 1 , {p}_{i} = 1}^{{Q}_{i} , {P}_{i}} {A}_{i} ( {p}_{i} , {q}_{i} ) exp ( - j 2 π {α}_{2} {Q}_{1} {Q}_{2} … {Q}_{i - 1} ( {q}_{i} - 1 ) ) exp ( j 2 π {α}_{1} {P}_{1} {P}_{2} … {P}_{i - 1} ( {p}_{i} - 1 ) )$$

where fᵢ(α₁, α₂) may be the array factor for the kernel Aᵢ, Aᵢ(pᵢ, qᵢ) may be pith row and qᵢth column element of the kernel Aᵢ, Aᵢ(pᵢ, qᵢ) may be an activated element in an event that Aᵢ(pᵢ, qᵢ) is 1, and Aᵢ(pᵢ, qᵢ) may not be an activated element in an event that Aᵢ(pᵢ, qᵢ) is 0. It may be represented as Aᵢ={Aᵢ(pᵢ, qᵢ)}∈{0,1}^{P}^{ᵢ}^{×Q}^{ᵢ}. In addition, the array elements Aᵢ(pᵢ, qᵢ) corresponding to slots or symbols allocated to UL, switching, or other functions, may not be available (i.e., may be inactivated) and be set to 0 in following design procedures.

In some cases, the array factors for the array A, the kernels A₁ to A_{L} may be represented as the following formula:

$$f ( {α}_{1} , {α}_{2} ) = {f}_{1} ( {α}_{1} , {α}_{2} ) {f}_{2} ( {α}_{1} , {α}_{2} ) … {f}_{L} ( {α}_{1} , {α}_{2} )$$

where A(p,q) may be equal to A_{L}(p_{L},q_{L})A_{L-1}(p_{L-1},q_{L-1}) . . . A₂(p₂,q₂)A₁(p₁,q₁) for p is equal to p₁+(p₂−1)P₁+ . . . +(p_{L}−1)P₁P₂ . . . P_{L-1} and q is equal to q₁+(q₂−1)Q₁+ . . . +(q_{L}−1)Q₁Q₂ . . . Q_{L-1}.

More specifically, based on the above designs, the design problem of the array A (with size P×Q) may be simplified to the design problems of kernels (i.e., the kernels A₁ to A_{L} with sizes Pₗ×Qₗ for l=1, . . . , L.).

In some implementations, a multi-stage procedure may be introduced to determine a multi-tier array (i.e., an array with multiple kernels) with PSL and HPBW conditions. In particular, the PSL in an interesting area and the HPBW of a main lobe of an array factor for the resulting multi-tier array may be less than predefined thresholds.

In some cases, in the first stage of a first-round operation, a first stage kernel of the kernels may be determined to have a first associated number of activated elements, which may be selected from available elements excluding elements associated with the non-DL symbols in the TDD channel, under that: (1) a PSL of the array factor for the first stage kernel in a specific area may be determined to be less than a first PSL threshold, and (2) an HPBW of the array factor for the first stage kernel may be determined to be less than a first HPBW threshold.

Then, in the second stage of the first-round operation, in an event that the first stage kernel is determined, a second stage kernel of the kernels may be determined to have a second associated number of activated elements, which may be selected from available elements excluding elements associated with the non-DL symbols in the TDD channel, under that: (1) a PSL of the array factor for a specific kernel (i.e., a Kronecker product of the first stage kernel and the second stage kernel) may be determined to be less than a second PSL threshold, and (2) an HPBW of array factor for the specific kernel may be determined to be less than a second HPBW threshold. In addition, the second stage kernel of the kernels may be determined to have the second associated number of activated elements under that: (1) the PSL of the array factor for the specific kernel in the main lobe area associated with the array factor for the first stage kernel may be determined to be less than the second PSL threshold, and (2) the HPBW of array factor for the specific kernel in the main lobe area associated with the array factor for the first stage kernel may be determined to be less than the second HPBW threshold.

Further, the specific kernel determined by the first stage kernel and the second stage kernel may be determined to be the first stage kernel in a subsequent operation (i.e., a second-round operation), and a third stage kernel may be determined to be the second stage kernel in the subsequent operation (i.e., a second-round operation). The second PSL threshold and second HPBW threshold can be redefined for each stage. Then, the same operation may be repeated until all the kernels are processed.

In other words, in the first stage of the first-round operation, the first stage kernel may be determined to have activated elements to satisfy the following conditions: (1) the activated elements may be selected from available elements excluding the elements associated with the non-DL symbols in the TDD channel, (2) in the interesting area (e.g., the specific area), the PSL of the array factor for the first stage kernel may be less than the first PSL threshold, and (3) the HPBW of the array factor for the first stage kernel may be less than the first HPBW threshold. In some examples, the first HPBW threshold may be an HPBW of an array factor for the first stage kernel, where all elements are activated elements.

In the second stage of the first-round operation, while keeping the first stage kernel fixed, the second stage kernel may be determined to have activated elements, which may be selected from available elements excluding elements associated with the non-DL symbols in the TDD channel, to satisfy the following conditions: (1) in the main lobe area of the first stage kernel, the PSL of the array factor for the specific kernel may be less than the second PSL, and (2) in the main lobe area of the first stage kernel, the HPBW of the array factor for the specific kernel may be less than the second HBPW threshold. In some examples, the second HPBW threshold may be determined based on the required resolution.

Further, in a subsequent operation (i.e., a second-round operation), (1) the specific kernel determined by the first stage kernel and the second stage kernel may be determined to be the first stage kernel, and (2) a third stage kernel may be determined to be the second stage kernel. Then, the same operation may be repeated until all the kernels are processed.

In some implementations, a multi-component procedure may be introduced to determine a multi-tier array (i.e., an array with multiple kernels) with PSL and HPBW conditions.

In some cases, the plurality of kernels may include L number of kernels. Regarding l including 1 to L−1, in lth component, a side lobe area associated with the array factor for the lth kernel may be determined to include one or more grating lobe areas associated with the array factor for the (l+1)th kernel, and the lth kernel may be determined to have a lth associated number of activated elements, which may be selected from available elements excluding elements associated with the non-DL symbols in the TDD channel, under that: (1) a PSL of the array factor for the lth kernel in the side lobe area associated with the lth kernel may be determined to be less than a first PSL threshold, and (2) an HPBW of the array factor for the lth kernel may be determined to be less than a first HPBW threshold.

Further, the Lth kernel may be determined to have a Lth associated number of activated elements, which may be selected from available elements excluding elements associated with the non-DL symbols in the TDD channel, under that: (1) a PSL of the array factor for the Lth kernel may be determined to be less than a Lth PSL threshold, and (2) an HPBW of the mainlobe of the Lth kernel may be determined to be less than a Lth HPBW threshold.

More specifically, the main lobe areas and the side lobe areas of the array factors for the kernels may be determined first. It should be noted that, because the array factor of the lth kernel (l≥2) in two dimensions may be naturally periodic, the main lobe areas and the side lobe areas within a single period of the array factor for the lth kernel (l>2) may be determined first. Subsequently, the main lobe areas (including the grating lobe areas) and the side lobe areas within the remaining periods of the array factor for the lth kernel (l≥2) may be determined.

In these cases, with the side lobe areas and the main lobe areas of array factors for the L kernels defined, the L number of kernels in the different components may be performed in parallel, and the determinations of the L number of kernels may be decoupled.

In some cases, the plurality of kernels may include L number of kernels. Regarding l including 1 to L−1, in lth component, a side lobe area associated with the array factor for the lth kernel may be determined to be one or more grating lobe areas associated with the array factor for the (l+1)th kernel, and the lth kernel may be determined to have the lth associated number of activated elements, which may be selected from available elements excluding elements associated with the non-DL symbols in the TDD channel, under that: (1) a PSL of the array factor for the lth kernel in the side lobe area associated with the lth kernel may be determined to be less than a the lth PSL threshold, and (2) an HPBW of the array factor for the lth kernel may be determined to be less than the lth HPBW threshold.

Further, the Lth kernel may be determined to have the Lth associated number of activated elements, which may be selected from available elements excluding elements associated with the non-DL symbols in the TDD channel, under that: (1) a PSL of the array factor for the Lth kernel may be determined to be less than the Lth PSL threshold, and (2) an HPBW of the Lth kernel may be determined to be less than the Lth HPBW threshold.

More specifically, the main lobe areas and the side lobe areas of the array factors for the kernels may be determined first. It should be noted that, because the array factor of the lth kernel (l≥2) in two dimensions may be naturally periodic, the main lobe areas and the side lobe areas within a single period of the array factor for the lth kernel (l≥2) may be determined first. Subsequently, the main lobe areas (including the grating lobe areas) and the side lobe areas within the remaining periods of the array factor for the lth kernel (l≥2) may be determined.

In these cases, with the side lobe areas and the main lobe areas of array factors for the L kernels defined, the L number of kernels in the different components may be performed in parallel, and the determinations of the L number of kernels may be decoupled.

In some implementations, L may be 2, and the plurality of kernels may include a first kernel and a second kernel. The 2-tier structure array may be a Kronecker product of the first kernel and the second kernel according to the following formula:

$$A = {A}_{2} ⊗ {A}_{1}$$

where A may be the array, A₁ may be the first kernel, and A₂ may be the second kernel. In addition, a size of the array may be P×Q, a size of A₁ may be P₁×Q₁, a size of A₂ may be P₂×Q₂, P may be equal to P₁×P₂, and Q may be equal to Q₁×Q₂.

More specifically, A∈{0,1}^{P×Q} may denote an array pattern of the array with size P×Q. When it is designed that P=P₁×P₂ and Q=Q₁×Q₂, array A with size P×Q may be determined by using: (1) the first kernel with size P₁×Q₁ while A₁ ∈{0,1}^{P}^{₁}^{×Q}^{₁} and (2) the second kernel with size P₂×Q₂ while A₂ ∈{0,1}^{P}^{₂}^{×Q}^{₂}, represented as A=A₂ ⊗A₁. In the first kernel with size P₁×Q₁, there may be P₁ elements in 1^{st} dimension and Q₁ elements in 2^{nd} dimension. In the second kernel with size P₂×Q₂, there may be P₂ number of first kernels in 1^{st} dimension and Q₂ number of first kernels in the 2^{nd} dimension.

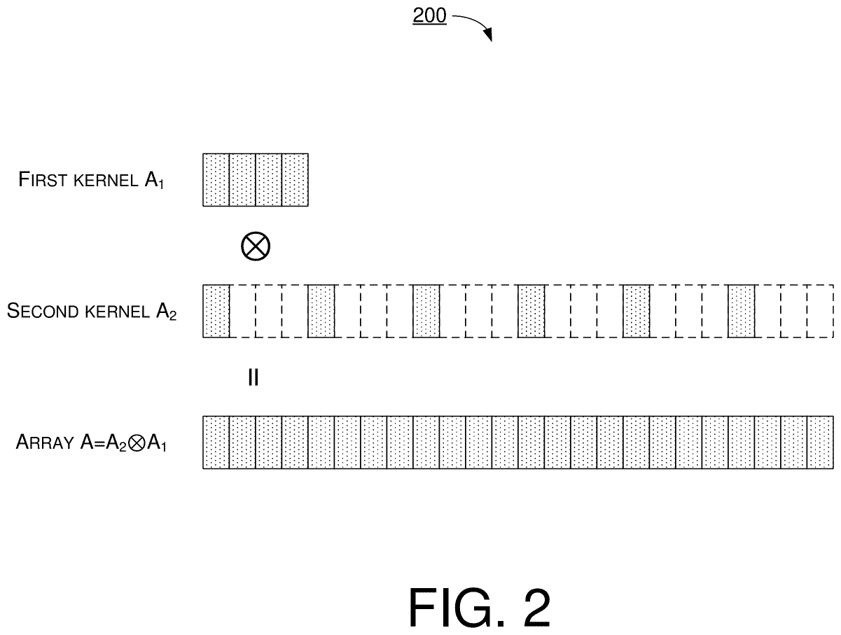

FIG. 2 illustrates an example scenario 200 under schemes in accordance with implementations of the present disclosure. For example, one-dimension two-kernel array is illustrated in FIG. 2. In particular, the first kernel is A₁, the second kernel is A₂, and the array (i.e., one-dimension two-kernel array) is A=A₂ ⊗A₁.

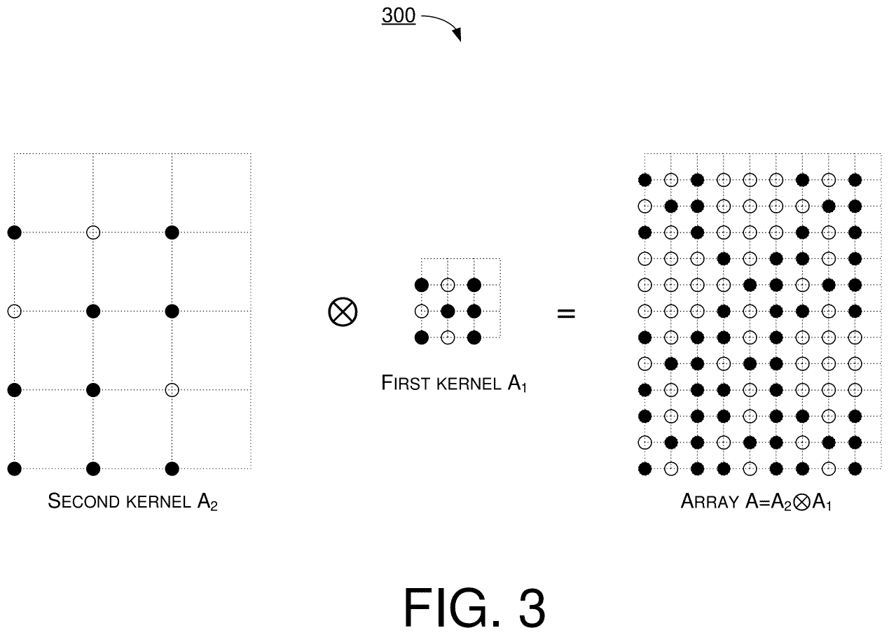

FIG. 3 illustrates an example scenario 300 under schemes in accordance with implementations of the present disclosure. For example, two-dimension two-kernel array is illustrated in FIG. 3. In particular, the first kernel is A₁, the second kernel is A₂, and the array (i.e., two-dimension two-kernel array) is A=A₂ ⊗A₁. As shown in FIG. 3, regarding the array determined by the first kernel and the second kernel, in the first kernel with size P₁×Q₁, there may be P₁ elements in 1^{st} dimension and Q₁ elements in 2^{nd} dimension; and in the second kernel with size P₂×Q₂, there may be P₂ number of first kernels in 1^{st} dimension and Q₂ number of first kernels in the 2^{nd} dimension.

In some cases, an array factor for the array A may be determined according to the following formula:

$$f ( {α}_{1} , {α}_{2} ) = {\sum }_{q = 1 , p = 1}^{Q , P} A ( p , q ) exp ( - j 2 π {α}_{2} ( q - 1 ) ) exp ( j 2 π {α}_{1} ( p - 1 ) )$$

where f(α₁, α₂) may be the array factor for the array, A(p, q) may be pth row and qth column element of the array A, A(p, q) may be an activated element in an event that A(p, q) is 1, and A(p, q) may not be an activated element in an event that A(p, q) is 0.

In some cases, an array factor for the first kernel A₁ may be determined according to the following formula:

$${f}_{1} ( {α}_{1} , {α}_{2} ) = {\sum }_{{q}_{1} = 1 , {p}_{1} = 1}^{{Q}_{1} , {P}_{1}} {A}_{1} ( {p}_{1} , {q}_{1} ) exp ( - j 2 π {α}_{2} ( {q}_{1} - 1 ) ) exp ( j 2 π {α}_{1} ( {p}_{1} - 1 ) )$$

where f₁(α₁, α₂) may be the array factor for the first kernel A₁, A₁(p₁, q₁) may be pᵢth row and q₁th column element of the first kernel A₁, A₁(p₁, q₁) may be an activated element in an event that A₁(p₁, q₁) is 1, and A₁(p₁, q₁) may not be an activated element in an event that A₁(p₁, q₁) is 0. It may be represented as A₁={A₁(p₁, q₁)}∈{0,1}^{P}^{₁}^{×Q}^{₁}. In addition, the array elements A₁(p₁,q₁) corresponding to slots or symbols allocated to UL or switching may not be available (i.e., may be inactivated) and be set to 0 in the following design procedures.

In some cases, an array factor for the second kernel A₂ may be determined according to the following formula:

$${f}_{2} ( {α}_{1} , {α}_{2} ) = {\sum }_{{q}_{2} = 1 , {p}_{2} = 1}^{{Q}_{2} , {P}_{2}} {A}_{2} ( {p}_{2} , {q}_{2} ) exp ( - j 2 π {α}_{2} {Q}_{1} ( {q}_{2} - 1 ) ) exp ( j 2 π {α}_{1} {P}_{1} ( {p}_{2} - 1 ) )$$

where f₂(α₁, α₂) may be the array factor for the second kernel A₂, A₂(P₂, q₂) may be P₂th row and q₂th column element of the second kernel A₂, A₂(P₂,q₂) may be an activated element in an event that A₂(P₂, q₂) is 1, and A₂(P₂, q₂) may not be an activated element in an event that A₂(P₂, q₂) is 0. In addition, the array elements A₂(p₂, q₂) corresponding to slots or symbols allocated to UL, switching, or other functions may not be available (i.e., may be inactivated) and be set to 0 in the following design procedures.

In some cases, the array factors for the array A, the first kernel A₁ and the second kernel A₂ may be represented as the following formula:

$$f ( {α}_{1} , {α}_{2} ) = {f}_{1} ( {α}_{1} , {α}_{2} ) {f}_{2} ( {α}_{1} , {α}_{2} )$$

where A(p, q) may be equal to A₂(p₂, q₂)A₁(p₁, q₁) for p is equal to p₁+(p₂−1)P₁ and q is equal to q₁+(q₂−1)Q₁.

More specifically, based on the above designs, the design problem of the array A (with size P×Q) may be simplified to the design problems of two kernels (i.e., the first kernel A₁ with size P₁×Q₁ and the second kernel A₂ with size P₂×Q₂).

It should be noted that there may be the following properties associated with the first kernel and the second kernel. Regarding property of the array factor for the first kernel with A₁(p₁, q₁)=1 for all p₁, q₁, (1) large unambiguous region: α₁ ∈[−0.5,0.5), α₂ ∈[−0.5,0.5), and (2) wide main lobe: half power beamwidth

$${Δ}_{{α}_{1}} = \frac{1}{{P}_{1}} , {Δ}_{{α}_{2}} = \frac{1}{{Q}_{1}} .$$

Regarding property of the array factor for the second kernel with A₂(p₂, q₂)=1 for all p₂, q₂, (1) small unambiguous region:

$${α}_{1} ∈ [ - \frac{1}{2 {P}_{1}} , \frac{1}{2 {P}_{1}} ) , {α}_{2} ∈ [ - \frac{1}{2 {Q}_{1}} , \frac{1}{2 {Q}_{1}} ) ,$$

and (2) fine mainlobe: half power beamwidth

$${Δ}_{{α}_{1}} = \frac{1}{{P}_{2} {P}_{1}} , {Δ}_{{α}_{2}} = \frac{1}{{Q}_{2} {Q}_{1}} .$$

Regarding periodic property of the array factor for any second kernel: for any (α₁, α₂), define

$${α}_{1} = {α}_{1}^{′} + \frac{1}{{P}_{1}} and {α}_{2} = {α}_{2}^{′} + \frac{1}{{Q}_{1}} ,$$

$${f}_{2} ( {α}_{1}^{′} , {α}_{2}^{′} ) = {f}_{2} ( {α}_{1} , {α}_{2} ) = {\sum }_{{q}_{2} = 1 , {p}_{2} = 1}^{{Q}_{2} , {P}_{2}} {A}_{2} ( {p}_{2} , {q}_{2} ) exp ( - j 2 π {Q}_{1} {α}_{2} ( {q}_{2} - 1 ) ) exp ( j 2 π {P}_{1} {α}_{1} ( {p}_{2} - 1 ) )$$

where f₂(α₁, α₂) may be a two-dimension periodic function with periods of

$$\frac{1}{{P}_{1}}$$

in 1^{st} dimension and

$$\frac{1}{{Q}_{1}}$$

in 2^{nd} dimension. f₂(α₁, α₂) may exhibit periodic grating lobes at

$$( {α}_{1} = \frac{{P}_{1}}{{P}_{1}} , {α}_{2} = \frac{{q}_{1}}{{Q}_{1}} ) ,$$

where pᵢ, q₁ may be integers and at least one of p₁, q₁ may be nonzero,

$$\vert {p}_{1} \vert \leq \frac{{P}_{1}}{2} , and \vert {q}_{1} \vert \leq \frac{{Q}_{1}}{2} .$$

In some implementations, the tiered array structure (i.e., the array designed based on the first kernel and the second kernel) may naturally provide a systematic multi-stage construction of a multi-dimensional array pattern for some network environments (e.g., ISAC environment). More specifically, based on the present disclosure, the first kernel with a large unambiguous region may be introduced to mitigate grating lobes (i.e., unwanted lobes having the same height as the main lobe) of the second kernel, and the second kernel with a fine main lobe may be introduced to sharpen the main lobe of the first kernel.

In addition, based on the present disclosure, the array may be designed to meet specific requirements by identifying the first kernel and the second kernel with the criteria mentioned. Due to the properties of the first kernel and the second kernel, the first kernel may suppress the grating lobes of the second kernel, while the second kernel may sharpen the mainlobe of the first kernel.

In some implementations, a two-stage procedure may be introduced to determine a 2-tier array (i.e., an array with two kernels) with PSL and HPBW conditions. In particular, the PSL in an interesting area and the HPBW of a main lobe of an array factor for the resulting 2-tier array may be less than predefined thresholds.

In some cases, in the first stage, the first kernel may be determined to have a first associated number (e.g., minimum number) of activated elements, which may be selected from available elements excluding elements associated with the non-DL symbols in the TDD channel, under that: (1) a peak side lobe level (PSL) of the array factor for the first kernel in a specific area may be determined to be less than a first PSL threshold, and (2) a half power beamwidth (HPBW) of the array factor for the first kernel may be determined to be less than a first HPBW threshold.

Then, in the second stage, in an event that the first kernel is determined, the second kernel may be determined to have a second associated number (e.g., minimum number) of activated elements, which may be selected from available elements excluding elements associated with the non-DL symbols in the TDD channel, under that: (1) a PSL of the array factor for the array may be determined to be less than a second PSL threshold, and (2) an HPBW of the array factor for the array may be determined to be less than a second HPBW threshold. In addition, the second kernel may be determined to have the second associated number (e.g., minimum number) of activated elements, which may be selected from available elements excluding elements associated with the non-DL symbols in the TDD channel, under that: (1) the PSL of the array factor for the array in the main lobe area associated with the array factor for the first kernel may be determined to be less than the second PSL threshold, and (2) the HPBW of the array factor for the array in the main lobe area associated with the array factor for the first kernel may be determined to be less than the second HPBW threshold.

In other words, in the first stage, the first kernel may be determined to have activated elements to satisfy the following conditions: (1) the activated elements may be selected from available elements excluding the elements associated with the non-DL symbols in the TDD channel, (2) in the interesting area (e.g., the specific area), the PSL of the array factor for the first kernel may be less than the first PSL threshold, and (3) the HPBW of the array factor for the first kernel may be less than the first HPBW threshold. In some examples, the first HPBW threshold may be an HPBW of an array factor for the first kernel, where all elements are activated elements.

In the second stage, while keeping the first kernel fixed, the second kernel may be determined to have activated elements to satisfy the following conditions: (1) the activated elements may be selected from available elements excluding the elements associated with the non-DL symbols in the TDD channel, (2) in the main lobe area of the first kernel, the PSL of the array factor for the array (e.g., reference signal (RS) pattern in some network environments) may be less than the second PSL, and (3) in the main lobe area of the first kernel, the HPBW of the array factor for the array may be less than the second HBPW threshold. In some examples, the second HPBW threshold may be determined based on the required resolution.

In some implementations, a two-component procedure may be introduced to determine a 2-tier array (i.e., an array with two kernels) with PSL and HPBW conditions.

In some cases, in the first component, a side lobe area associated with the array factor for the first kernel may be determined to include one or more grating lobe areas associated with the array factor for the second kernel, and the first kernel may be determined to have a first associated number of activated elements, which may be selected from available elements excluding elements associated with the non-DL symbols in the TDD channel, under that: (1) a PSL of the array factor for the first kernel in the side lobe area associated with the first kernel may be determined to be less than a first PSL threshold, and (2) an HPBW of the array factor for the first kernel may be determined to be less than a first HPBW threshold.

Then, in the second component, the second kernel may be determined to have a second associated number of activated elements, which may be selected from available elements excluding elements associated with the non-DL symbols in the TDD channel, under that: (1) a PSL of the array factor for the second kernel may be determined to be less than a second PSL threshold, and (2) an HPBW of the second kernel may be determined to be less than a second HPBW threshold.

More specifically, the main lobe areas and the side lobe areas of the array factors for the kernels (i.e., the first kernel and the second kernel) may be determined first. It should be noted that, because the array factor of the second kernel in two dimensions may be naturally periodic, the main lobe areas and the side lobe areas within a single period of the array factor for the second kernel may be determined first. Subsequently, the main lobe areas (including the grating lobe areas) and the side lobe areas within the remaining periods of the array factor for the second kernel may be determined.

Next, the side lobe area of the array factor for the first kernel may be determined to include the one or more grating lobe areas of the array factor for the second kernel. In the first component, the first kernel may be determined to have activated elements to satisfy the following conditions: (1) the activated elements may be selected from available elements excluding the element associated with the non-DL symbols in the TDD channel, (2) in the side lobe area of the array factor for the first kernel, the PSL of the array factor for the first kernel may be less than the first PSL threshold, and (3) the HPBW of the array factor of the first kernel may be less than the first HPBW. In some examples, the first HPBW threshold may be an HPBW of an array factor for the first kernel, where all elements are activated elements.

In the second component, the second kernel may be determined to have activated elements to satisfy the following conditions: in one period of the array factor for the second kernel, (1) the activated elements may be selected from available elements excluding the elements associated with the non-DL symbols in the TDD channel, (2) the PSL of the array factor for the second kernel may be less than the second PSL threshold, and (3) the HPBW of the array factor for the second kernel may be less than the second HPBW threshold. In some examples, the second HPBW threshold may be determined based on the required resolution.

It should be noted that, in these cases, with the side lobe areas and the main lobe areas of array factors for the kernels defined, the first component and the second component may be performed in parallel, and the determinations of the first kernel and the second kernel may be decoupled.

In some cases, in the first component, a side lobe area associated with the array factor for the first kernel may be determined to be one or more grating lobe areas associated with the array factor for the second kernel (i.e., the side lobe area associated with the array factor for the first kernel may be the same as the grating lobe area associated with the array factor for the second kernel), and the first kernel may be determined to have a first associated number of activated elements, which may be selected from available elements excluding elements associated with the non-DL symbols in the TDD channel, under that: (1) a PSL of the array factor for the first kernel in the side lobe area associated with the first kernel may be determined to be less than a first PSL threshold, and (2) an HPBW of the array factor for the first kernel may be determined to be less than a first HPBW threshold.

Then, in the second component, the second kernel may be determined to have a second associated number of activated elements, which may be selected from available elements excluding elements associated with the non-DL symbols in the TDD channel, under that: (1) a PSL of the array factor for the second kernel may be determined to be less than a second PSL threshold, and (2) an HPBW of the second kernel may be determined to be less than a second HPBW threshold.

More specifically, the main lobe areas and the side lobe areas of the array factors for the kernels (i.e., the first kernel and the second kernel) may be determined first. It should be noted that, because the array factor of the second kernel in two dimensions may be naturally periodic, the main lobe areas and the side lobe areas within a single period of the array factor for the second kernel may be determined first. Subsequently, the main lobe areas (including the grating lobe areas) and the side lobe areas within the remaining periods of the array factor for the second kernel may be determined.

Next, the side lobe area of the array factor for the first kernel may be determined to be the one or more grating lobe areas of the array factor for the second kernel. In the first component, the first kernel may be determined to have activated elements to satisfy the following conditions: (1) the activated elements may be selected from available elements excluding the elements associated with the non-DL symbols in the TDD channel, (2) in the side lobe area of the array factor for the first kernel, the PSL of the array factor for the first kernel may be less than the first PSL threshold, (3) the HPBW of the array factor of the first kernel may be less than the first HPBW. In some examples, the first HPBW threshold may be an HPBW of an array factor for the first kernel, where all elements are activated elements.

In the second component, the second kernel may be determined to have activated elements to satisfy the following conditions: in one period of the array factor for the second kernel, (1) the activated elements may be selected from available elements excluding elements associated with the non-DL symbols in the TDD channel, (2) the PSL of the array factor for the second kernel may be less than the second PSL threshold, and (3) the HPBW of the array factor for the second kernel may be less than the second HPBW threshold. In some examples, the second HPBW threshold may be determined based on the required resolution.

It should be noted that, in these cases, with the side lobe areas and the main lobe areas of array factors for the kernels defined, the first component and the second component may be performed in parallel, and the determinations of the first kernel and the second kernel may be decoupled.

In some implementations, an operation may be provided for determining activated elements in the kernel in each stage of the mentioned multi-kernel array determination procedure. In particular, regarding a kernel of the plurality of kernels, a first number of activated elements may be determined. Then, a PSL of an array factor for the kernel may be determined. Next, whether the PSL of the array factor for the kernel meets a target PLS may be determined. In an event that the PSL of the array factor for the kernel meets a target PLS, the kernel may be selected. In an event that the PSL of the array factor for the kernel does not meet the targeted value, the kernel may be added with an additional activated element, and the procedure repeats until the PSL of the array factor for the kernel meets the targeted value.

More specifically, in each stage, a group of M elements may be initialized as selected elements, which may be determined according to a resolution constraint. In some cases, to attain the finest resolution offered by a two-dimensional kernel of a specified size, the kernel may be initialized with 4 or 3 activated elements (i.e., M=4 or 3) positioned at the corners of the two-dimensional kernel. In some cases, to attain the finest resolution offered by a one-dimensional kernel of a specified size, the kernel may be initialized with 2 activated elements (i.e., M=2) positioned at two ends of the one-dimensional kernel.

Then, for m>M, the m-th element in the kernel may be considered. Presuming that the (m−1) previously selected elements are fixed, the remaining unselected elements may be considered as potential activated element positions. Next, a PSL for the array factor of the kernel may be determined by adding one potential activated element, and then selecting the potential activated element associated with the minimum PSL as the m-th element of the array. The iterative process proceeds by incrementing m until either the target PSL threshold is met, or the maximum allowable number of selected elements is reached.

In some implementations, in addition to the above-described iterative process, sensing resource availability may be introduced for each kernel of the plurality of kernels.

In some cases, regarding the ISAC system using a time-domain multiplexing scheme, for indices q that do not belong to the set Q_{D}, the q-th symbol may not be allocated for sensing, and the elements in the q-th symbol may be treated as unavailable elements in the design. Accordingly, a(p, q) may be set to zero for q∈Q_{D}.

In some cases, regarding the ISAC system using a frequency-domain multiplexing scheme, where P_{D} may represent a set of subcarrier indices of subcarriers that may be used for sensing in a general sense, a similar signal model and method may be obtained by replacing q∈Q_{D} with p∈P_{D}. For p∈P_{D}, a DL transmitted baseband signal in the qth symbol may be given by:

$${x}^{q} ( t ) = {\sum }_{p ∈ {P}_{D}} s ( p , q ) {e}^{j 2 π ( p - 1 ) {Δ}_{f} t} δ ( t - ( q - 1 ) {T}_{s} )$$

$$with$$

$$δ ( t ) = \{ \begin{matrix}1 , & t ∈ [ - {T}_{cp} , T ] \\ 0 , & otherwise\end{matrix}$$

where t may denote the time and s(p,q) may be the transmitted symbol at the pth subcarrier of the qth symbol.

In some cases, regarding the ISAC system using a time-frequency domain multiplexing scheme, where S_{D} may represent a set of subcarrier-symbol indices of the resource elements that may be used for sensing in a general sense, a similar signal model and method may be obtained by replacing q∈Q_{D} with (p, q)∈S_{D}.

Furthermore, a half-wavelength spaced uniform planar array may be employed when a far-field condition is satisfied. An array response for the azimuth angle θ and elevation angle η may be expressed as:

$$P ( θ , η ) = \frac{1}{{N}_{D}} {\sum }_{p = 1}^{P} {\sum }_{q = 1}^{Q} a ( p , q ) {e}^{π s i n θ} {e}^{j π s i n η}$$

where A={a(p, q)}∈{0,1}^{P×Q} may represent a sparse antenna pattern and N_{D} may denote the number of nonzero elements in A. The aforementioned method may be readily extended to address the design of on-off element patterns in spatial domain antenna arrays.

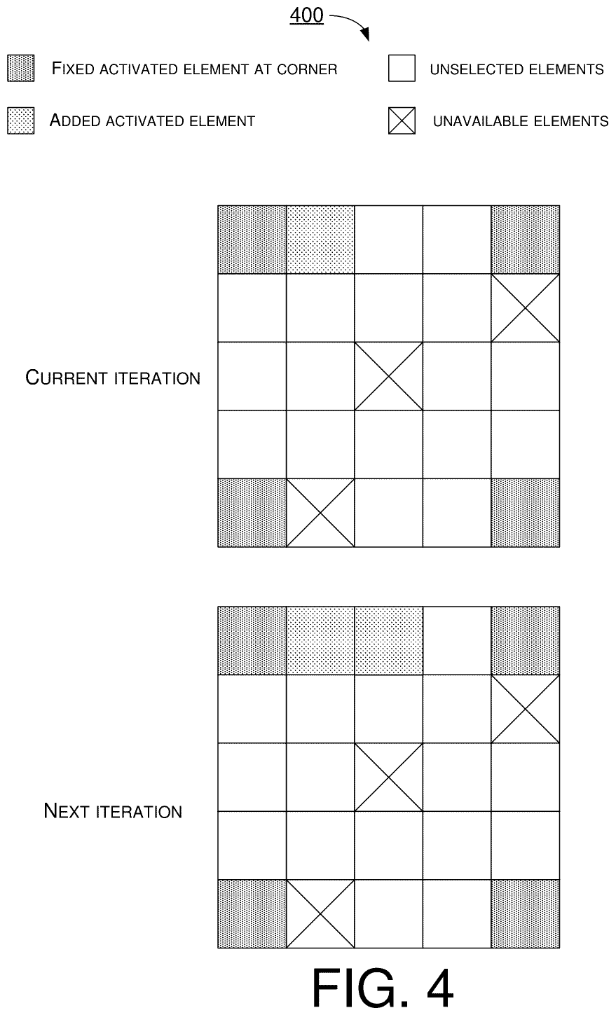

FIG. 4 illustrates an example scenario 400 under schemes in accordance with implementations of the present disclosure. For example, when determining a kernel of size 5×5, the kernel is initially configured with 4 activated elements (i.e., M=4) positioned at its corners, and the 4 activated elements are selected from available elements excluding unavailable elements associated with the non-DL symbols in the TDD channel. During a current iteration, one activated element is added to one of the remaining unselected elements. A PSL of an array factor for the kernel is then calculated. If the PSL meets the target PSL threshold or the maximum allowable number of selected elements (in this example, the maximum allowable number of selected elements is 18, except for the fixed 4 activated elements at the corners and 3 unavailable elements) is reached, the kernel is finalized. Otherwise, the process continues to the next iteration, where another activated element is added to one of the remaining unselected elements. The iteration is repeated until the PSL meets the target PSL threshold or the maximum allowable number of selected elements is reached.

In some implementations, the multi-kernel structured array of the present disclosure may be utilized for performance pilot placement design for pilot-based sensing and positioning in OFDM ISAC systems, sparse transmit/receive antenna array design for beamforming in massive MIMO, and other applications requiring large-scale sparse arrays.

In some cases, the multi-kernel structured array of the present disclosure may be utilized for sensing and positioning in OFDM ISAC systems, enabling high resolution and low sidelobe levels for sensing, while ensuring minimal communication overhead.

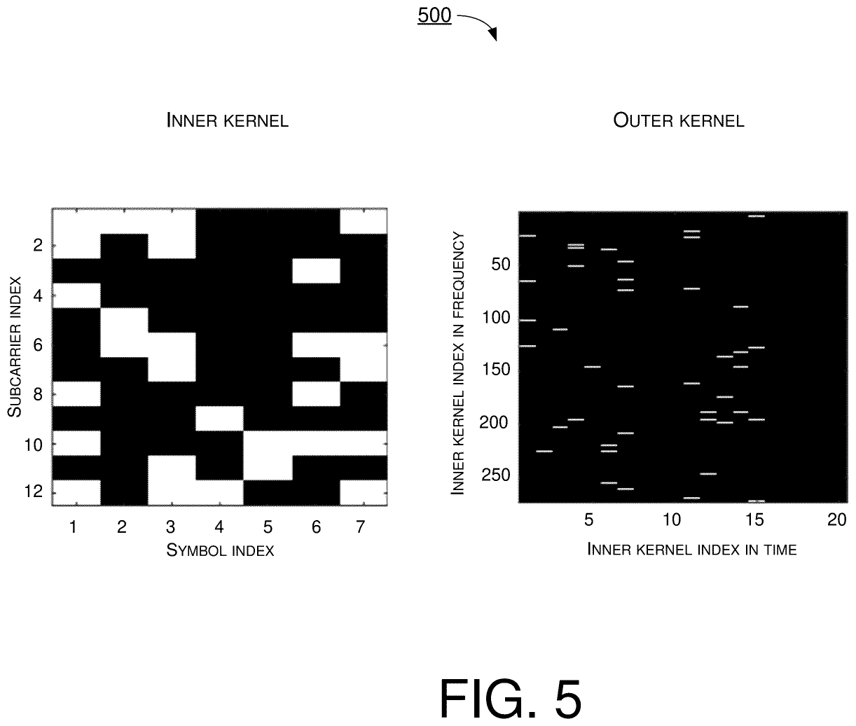

FIG. 5 illustrates an example scenario 500 under schemes in accordance with implementations of the present disclosure. For example, an OFDM ISAC system has a TDD channel using a TDD pattern DDDSUDDSUU (D for DL slot, S for switching slot, and U for UL slot). In this example, a first half slot of an S slot is used for DL sensing, i.e., D and half of S are associated with DL symbols, and U and the other half of S are associated with non-DL symbols. P₁=12 and Q₁=7. P₂=273 and Q₂=20. The first PSL threshold and the second PSL threshold are set to −13 dB and −10.5 dB, respectively. The required range and Doppler resolution are set as the same as that obtained when all REs are used for pilots. In this example, there exist some unavailable elements that are not allocated for sensing (i.e., are associated with non-DL symbols), in outer kernel P₂Q₂.

According to these setting, when (a) in the first stage, the side lobe area associated with the array factor for the first kernel is determined to be the grating lobe area associated with the array factor for the second kernel, and the first kernel is determined to have the first associated number of activated elements under that: (1) a PSL of the array factor for the first kernel in the side lobe area associated with the first kernel is determined to be less than the first PSL threshold, and (2) an HPBW of the array factor for the first kernel is determined to be less than the first HPBW threshold; and (b) in the second stage, the second kernel is determined to have the second associated number of activated elements under that: (1) a PSL of the array factor for the second kernel is determined to be less than the second PSL threshold, and (2) an HPBW of the second kernel is determined to be less than a second HPBW threshold, the array is determined. Based on the determined array, a two-kernel pilot pattern is determined to be the same as the array, and the percentage of REs used in the two-kernel pilot pattern is:

$$\frac{28 \times 70}{12 \times 7 \times 273 \times 20} = 0.43 \% .$$

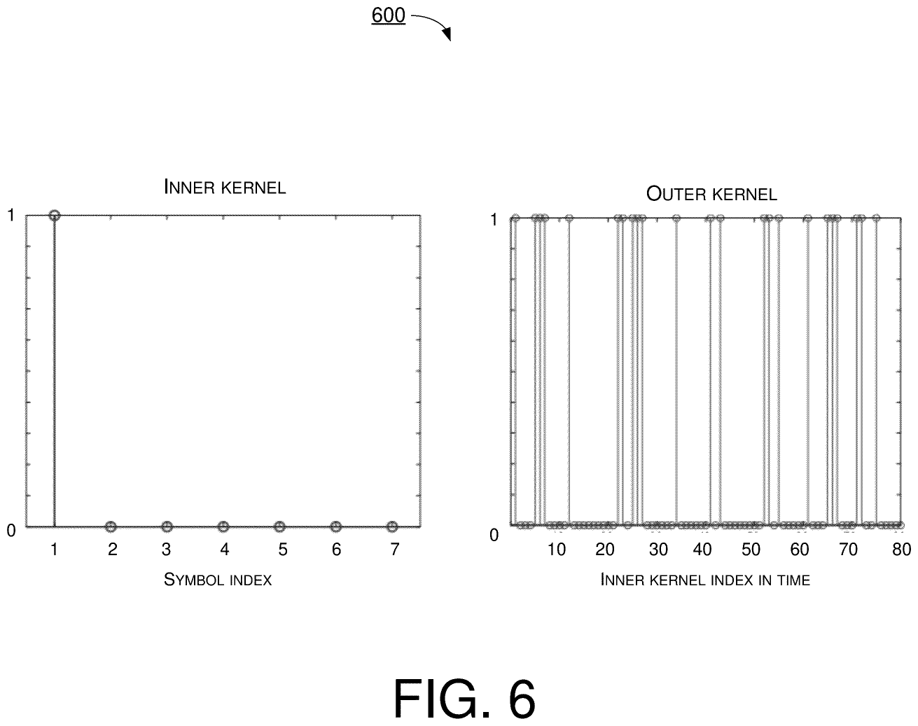

FIG. 6 illustrates an example scenario 600 under schemes in accordance with implementations of the present disclosure. For example, an OFDM ISAC system has a TDD channel using a TDD pattern DDDSUDDSUU (D for DL slot, S for switching slot, and U for UL slot). In this example, a first half slot of an S slot is used for DL sensing, i.e., D and half of S are associated with DL symbols, and U and the other half of S are associated with non-DL symbols. Carrier frequency is 7 GHz, subcarrier spacing is 30 kHz, and total time is 20 milliseconds (ms). P₁=7 and Q₁=1. P₂=80 and Q₂=1. The first PSL threshold and the second PSL threshold are set to −13 dB and −9.5 dB, respectively. The required range and Doppler resolution are set as the same as that obtained when all REs are used for pilots. In this example, there exist some unavailable elements that are not allocated for sensing (i.e., are associated with non-DL symbols), in outer kernel P₂Q₂.

Further, in this example, the target velocity range is between −46 and 46 m/s. Using the above methods for sensing resource allocation, the inner kernel is chosen to be A₁=[1 0 0 0 0 0 0]. This configuration indicates that 1 out of every 7 symbols is utilized for sensing in order to attain the desired maximum unambiguous velocity. The number of non-zero elements in the outer kernel is 23. The sparse pattern provides a low PSL of −9 dB at a low overhead of 4.1% within 20 ms.

### Illustrative Implementations

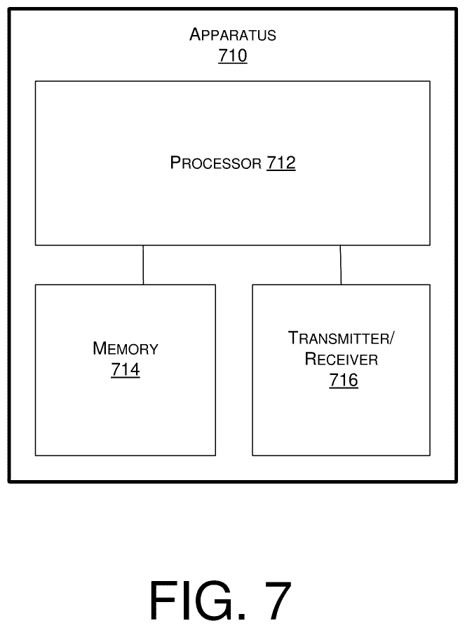

FIG. 7 illustrates an example apparatus 710 in accordance with an implementation of the present disclosure. Apparatus 710 may perform various functions to implement schemes, techniques, processes and methods described herein pertaining to determining array associated with resource allocation in an ISAC system with TDD channel with respect to TX and RX in mobile communications, including scenarios/schemes described above as well as process 800 described below.

Apparatus 710 may be: (1) a part of an electronic apparatus, which may be a UE such as a portable or mobile apparatus, a wearable apparatus, a wireless communication apparatus or a computing apparatus, or (2) a part of a network apparatus, which may be a network node such as a satellite, a base station, a small cell, a router or a gateway. For instance, apparatus 710 may be implemented in a smartphone, a smartwatch, a personal digital assistant, a digital camera, or a computing equipment such as a tablet computer, a laptop computer or a notebook computer. Apparatus 710 may also be a part of a machine type apparatus, which may be an IoT, NB-IoT, or IIoT apparatus such as an immobile or a stationary apparatus, a home apparatus, a wire communication apparatus or a computing apparatus. For instance, apparatus 710 may be implemented in a smart thermostat, a smart fridge, a smart door lock, a wireless speaker or a home control center. For instance, apparatus 710 may be implemented in an eNodeB in an LTE network, in a gNB in a 5G/NR, IoT, NB-IoT or IIoT network or in a satellite or base station in a 6G network. Alternatively, apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 710 may include at least some of those components shown in FIG. 7 such as a processor 712, for example. Apparatus 710 may further include one or more other components not pertinent to the proposed scheme of the present disclosure (e.g., internal power supply, display device and/or user interface device), and, thus, such component(s) of apparatus 710 are neither shown in FIG. 7 nor described below in the interest of simplicity and brevity.

In one aspect, processor 712 may be implemented in the form of one or more single-core processors, one or more multi-core processors, or one or more CISC processors. That is, even though a singular term “a processor” is used herein to refer to processor 712, processor 712 may include multiple processors in some implementations and a single processor in other implementations in accordance with the present disclosure. In another aspect, processor 712 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 712 is a special-purpose machine specifically designed, arranged and configured to perform specific tasks including determining array associated with resource allocation in an ISAC system with TDD in a device (e.g., as represented by apparatus 710) in accordance with various implementations of the present disclosure.

In some implementations, apparatus 710 may also include a transmitter and/or a receiver (transmitter/receiver) 716 coupled to processor 712 and capable of wirelessly transmitting and receiving data. In other words, processor 712 may transmit/receive the data such as configuration, message, signal, information, indicator, etc. via transmitter/receiver 716. In some implementations, apparatus 710 may further include a memory 714 coupled to processor 712 and capable of being accessed by processor 712 and storing data therein. Accordingly, apparatus 710 may wirelessly communicate with other communication node via transmitter/receiver 716.

In some implementations, memory 714 may include a type of random-access memory (RAM) such as dynamic RAM (DRAM), static RAM (SRAM), thyristor RAM (T-RAM) and/or zero-capacitor RAM (Z-RAM). Alternatively, or additionally, memory 714 may include a type of read-only memory (ROM) such as mask ROM, programmable ROM (PROM), erasable programmable ROM (EPROM) and/or electrically erasable programmable ROM (EEPROM). Alternatively, or additionally, memory 714 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

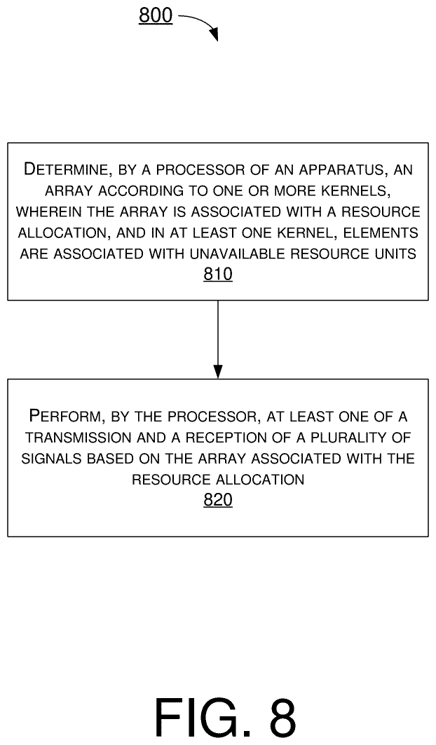

FIG. 8 illustrates an example process 800 in accordance with an implementation of the present disclosure. Process 800 may be an example implementation of above scenarios/schemes, whether partially or completely, with respect to determining array associated with resource allocation in an ISAC system with TDD of the present disclosure. Process 800 may represent an aspect of implementation of features of apparatus 710 as a TX or RX. Process 800 may include one or more operations, actions, or functions as illustrated by one or more of blocks 810 to 820. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by TX or RX such as apparatus 710 or machine type devices. Solely for illustrative purposes and without limitation, process 800 is described below in the context of apparatus 710. Process 800 may begin at block 810.

At block 810, process 800 may involve processor 712 of apparatus 710 determining an array according to one or more kernels. The array may be associated with a resource allocation. In at least one kernel, elements are associated with unavailable resource units. Process 800 may proceed from block 810 to block 820.

At block 820, process 800 may involve processor 712 of apparatus 710 performing at least one of a transmission and a reception of a plurality of signals based on the array associated with the resource allocation.

In some implementations, the unavailable resource units may include non-DL symbols in a TDD channel that are inactivated for either the transmission or the reception.

In some implementations, the non-DL symbols may include UL symbols of at least one UL slot.

In some implementations, the non-DL symbols may include a part of symbols of at least one switching slot.

In some implementations, the one or more kernels may include kernels A₁ to A_{L}, and the array may be a Kronecker product of the kernels A₁ to A_{L} according to the following formula:

$$A = {A}_{L} ⊗ {A}_{L - 1} ⊗ {A}_{L - 2} ⊗ … ⊗ {A}_{2} ⊗ {A}_{1}$$

A size of the array may be P×Q, a size of Aᵢ may be Pᵢ×Qᵢ, P may be equal to P₁×P₂× . . . ×P_{L-1}×P_{L}, and Q may be equal to Q₁×Q₂× . . . ×Q_{L-1}×Q_{L}.

In some implementations, a first stage kernel of the one or more kernels may be determined to have a first associated number of activated elements under that: a PSL of the array factor for the first stage kernel in a specific area may be determined to be less than a first PSL threshold, and an HPBW of the array factor for the first stage kernel may be determined to be less than a first HPBW threshold. In an event that the first stage kernel is determined, a second stage kernel may be determined to have a second associated number of activated elements under that: a PSL of the array factor for the array in a main lobe area associated with the array factor for the first stage kernel may be determined to be less than a second PSL threshold, and an HPBW of array factor for the array in the main lobe area associated with the array factor for the first stage kernel may be determined to be less than a second HPBW threshold. A kernel determined by the first stage kernel and the second stage kernel may be determined to be the first stage kernel in a subsequent operation, and a third stage kernel may be determined to be the second stage kernel in the subsequent operation.

In some implementations, the PSL of the array factor for the array in a main lobe area associated with the array factor for the first stage kernel may be determined to be less than the second PSL threshold, and the HPBW of array factor for the array in the main lobe area associated with the array factor for the first stage kernel may be determined to be less than the second HPBW threshold. A kernel determined by the first stage kernel and the second stage kernel is determined to be the first stage kernel in a subsequent operation, and a third stage kernel is determined to be the second stage kernel in the subsequent operation.

In some implementations, process 800 may involve processor 712 of apparatus 710 determining a kernel of the one or more kernels. A first number of activated elements are selected from available elements excluding the elements associated with the unavailable resource units. Process 800 may involve processor 712 of apparatus 710 determining the PSL of the array factor for the array. Process 800 may involve processor 712 of apparatus 710 determining whether the PSL of the array factor for the array meets a target value.

In some implementations, the one or more kernels may include L number of kernels. A sidelobe area associated with the array factor for a l-th kernel may be determined to include one or more grating lobe areas associated with the array factor for a (l+1)-th kernel while l includes 1 to L−1, and the lth kernel may be determined to have a lth associated number of activated elements, for l=1, . . . , L−1 under that: a PSL of the array factor for the l-th kernel in a side lobe area associated with the l-th kernel may be determined to be less than a lth PSL threshold, and an HPBW of the array factor for the l-th kernel may be determined to be less than a lth HPBW threshold. The Lth kernel may be determined to have a Lth associated number of activated elements under that: a PSL of the array factor for the Lth kernel may be determined to be less than a Lth PSL threshold, and an HPBW of the Lth kernel may be determined to be less than a Lth HPBW threshold.

In some implementations, the sidelobe area associated with the array factor for the l-th kernel may be determined to be the one or more of grating lobe area associated with the array factor for the (l+1)-th kernel.

In some implementations, process 800 may involve processor 712 of apparatus 710 determining a kernel of the one or more kernels. A first number of activated elements may be selected from available elements excluding the elements associated with the unavailable resource units. Process 800 may involve processor 712 of apparatus 710 determining a PSL of an array factor for the kernel. Process 800 may involve processor 712 of apparatus 710 determining whether the PSL of the array factor for the kernel meets a target value.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, an array according to one or more kernels, wherein the array is associated with a resource allocation, and in at least one kernel, elements are associated with unavailable resource units; and
performing, by the processor, at least one of a transmission and a reception of a plurality of signals based on the array associated with the resource allocation.

2. The method of claim 1, wherein the unavailable resource units include non-Downlink (non-DL) symbols in a Time-Division Duplexing (TDD) channel that are inactivated for either the transmission or the reception.

3. The method of claim 2, wherein the non-DL symbols include Uplink (UL) symbols of at least one UL slot.

4. The method of claim 3, wherein the non-DL symbols include a part of symbols of at least one switching slot.

5. The method of claim 1, wherein the one or more kernels includes kernels A₁ to A_{L}, and the array is a Kronecker product of the kernels A₁ to A_{L} according to the following formula:
$$A = {A}_{L} ⊗ {A}_{L - 1} ⊗ {A}_{L - 2} ⊗ … ⊗ {A}_{2} ⊗ {A}_{1}$$
wherein a size of the array is P×Q, a size of Aᵢ is Pᵢ×Qᵢ, P is equal to P₁×P₂× . . . ×P_{L-1}×P_{L}, and Q is equal to Q₁×Q₂× . . . ×Q_{L-1}×Q_{L}.

6. The method of claim 5, wherein a first stage kernel of the one or more kernels is determined to have a first associated number of activated elements under that
a peak side lobe level (PSL) of an array factor for the first stage kernel in a specific area is determined to be less than a first PSL threshold, and a half power beamwidth (HPBW) of the array factor for the first stage kernel is determined to be less than a first HPBW threshold, and
wherein, in an event that the first stage kernel is determined, a second stage kernel is determined to have a second associated number of activated elements under that
a PSL of an array factor for the array is determined to be less than a second PSL threshold, and an HPBW of array factor for the array is determined to be less than a second HPBW threshold.

7. The method of claim 6, wherein the PSL of the array factor for the array in a main lobe area associated with the array factor for the first stage kernel is determined to be less than the second PSL threshold, and the HPBW of array factor for the array in the main lobe area associated with the array factor for the first stage kernel is determined to be less than the second HPBW threshold, and
wherein a kernel determined by the first stage kernel and the second stage kernel is determined to be the first stage kernel in a subsequent operation, and a third stage kernel is determined to be the second stage kernel in the subsequent operation.

8. The method of claim 6, further comprising:
determining, by the processor, a kernel of the one or more kernels, wherein a first number of activated elements are selected from available elements excluding the elements associated with the unavailable resource units;
determining, by the processor, the PSL of the array factor for the array; and
determining, by the processor, whether the PSL of the array factor for the array meets a target value.

9. The method of claim 5, wherein the one or more kernels include L number of kernels, a sidelobe area associated with an array factor for a l-th kernel is determined to include one or more grating lobe areas associated with the array factor for a (l+1)-th kernel while l ranges from 1 to L−1, and, for l=1, . . . , L−1, the l-th kernel is determined to have a lth associated number of activated elements under that
a peak side lobe level (PSL) of the array factor for the l-th kernel in a side lobe area associated with the l-th kernel is determined to be less than a lth PSL threshold, and a half power beamwidth (HPBW) of the array factor for the l-th kernel is determined to be less than a lth HPBW threshold, and
wherein, the Lth kernel is determined to have a Lth associated number of activated elements under that
a PSL of the array factor for the Lth kernel is determined to be less than a Lth PSL threshold, and an HPBW of the Lth kernel is determined to be less than a Lth HPBW threshold.

10. The method of claim 9, wherein the sidelobe area associated with the array factor for the l-th kernel is determined to be the one or more grating lobe areas associated with the array factor for the (l+1)-th kernel.

11. The method of claim 1, further comprising:
determining, by the processor, a kernel of the one or more kernels, wherein a first number of activated elements are selected from available elements excluding the elements associated with the unavailable resource units;
determining, by the processor, a peak side lobe level (PSL) of an array factor for the kernel; and
determining, by the processor, whether the PSL of the array factor for the kernel meets a target value.

12. An apparatus, comprising:
at least one of a transmitter and a receiver which, during operation, wirelessly communicates with a wireless network; and
a processor communicatively coupled to the at least one of the transmitter and the receiver, the processor being configured to perform operations comprising:
determining an array according to one or more kernels, wherein the array is associated with a resource allocation, and in at least one kernel, elements are associated with unavailable resource units; and
performing, via the at least one of the transmitter and the receiver, at least one of a transmission and a reception of a plurality of signals based on the array associated with the resource allocation.

13. The apparatus of claim 12, wherein the unavailable resource units include non-Downlink (non-DL) symbols in a Time-Division Duplexing (TDD) channel that are inactivated for either the transmission or the reception.

14. The apparatus of claim 13, wherein the non-DL symbols include Uplink (UL) symbols of at least one UL slot.

15. The apparatus of claim 14, wherein the non-DL symbols include a part of symbols of at least one switching slot.

16. The apparatus of claim 12, wherein the one or more kernels includes kernels A₁ to A_{L}, and the array is a Kronecker product of the kernels A₁ to A_{L} according to the following formula:
$$A = {A}_{L} ⊗ {A}_{L - 1} ⊗ {A}_{L - 2} ⊗ … ⊗ {A}_{2} ⊗ {A}_{1}$$
wherein a size of the array is P×Q, a size of Aᵢ is Pᵢ×Qᵢ, P is equal to P₁×P₂× . . . ×P_{L-1}×P_{L}, and Q is equal to Q₁×Q₂× . . . ×Q_{L-1}×Q_{L}.

17. The apparatus of claim 16, wherein a first stage kernel of the one or more kernels is determined to have a first associated number of activated elements under that
a peak side lobe level (PSL) of an array factor for the first stage kernel in a specific area is determined to be less than a first PSL threshold, and a half power beamwidth (HPBW) of the array factor for the first stage kernel is determined to be less than a first HPBW threshold, and
wherein, in an event that the first stage kernel is determined, a second stage kernel is determined to have a second associated number of activated elements under that
a PSL of an array factor for the array is determined to be less than a second PSL threshold, and an HPBW of the array factor for the array is determined to be less than a second HPBW threshold.

18. The apparatus of claim 17, wherein the PSL of the array factor for the array in a main lobe area associated with the array factor for the first stage kernel is determined to be less than the second PSL threshold, and the HPBW of array factor for the array in the main lobe area associated with the array factor for the first stage kernel is determined to be less than the second HPBW threshold, and
wherein a kernel determined by the first stage kernel and the second stage kernel is determined to be the first stage kernel in a subsequent operation, and a third stage kernel is determined to be the second stage kernel in the subsequent operation.

19. The apparatus of claim 17, wherein the processor further performs operations comprising:
determining a kernel of the one or more kernels, wherein a first number of activated elements are selected from available elements excluding the elements associated with the unavailable resource units;
determining the PSL of the array factor for the array; and
determining whether the PSL of the array factor for the array meets a target value.

20. The apparatus of claim 16, wherein the one or more kernels include L number of kernels, a sidelobe area associated with an array factor for a l-th kernel is determined to include one or more grating lobe areas associated with the array factor for a (l+1)-th kernel while l ranges from 1 to L−1, and, for l=1, . . . , L−1, the l-th kernel is determined to have a lth associated number of activated elements under that
a peak side lobe level (PSL) of the array factor for the l-th kernel in a side lobe area associated with the l-th kernel is determined to be less than a lth PSL threshold, and a half power beamwidth (HPBW) of the array factor for the l-th kernel is determined to be less than a lth HPBW threshold, and
wherein, the Lth kernel is determined to be with a Lth associated number of activated elements under that
a PSL of the array factor for the Lth kernel is determined to be less than a Lth PSL threshold, and an HPBW of the Lth kernel is determined to be less than a Lth HPBW threshold.

21. The apparatus of claim 20, wherein the sidelobe area associated with the array factor for the l-th kernel is determined to be the one or more grating lobe areas associated with the array factor for the (l+1)-th kernel.

22. The apparatus of claim 12, wherein the processor further performs operations comprising:
determining a kernel of the one or more kernels, wherein a first number of activated elements are selected from available elements excluding the elements associated with the unavailable resource units;
determining a peak side lobe level (PSL) of an array factor for the kernel; and
determining whether the PSL of the array factor for the kernel meets a target value.
